(19) United States
(12) Patent Application Publication
(10) Pub. No.: US 2003/0104167 A1
(43) Pub. Date: Jun. 5, 2003

(54) Method for manufactuing three-dimensional objects from a flat workpiece by a continuous cut and objects produced by the above method

(76) Inventors: Gennadiy Spektor, San Francisco, CA (US); Leonid Spektor, San Francisco, CA (US)

Correspondence Address: Gennadiy Spektor, 100 Font Boulevard Apt. 7A, San Francisco, CA, 94132, US

(21) Appl. No.: 09/999,509

(22) Filed: Dec. 4, 2001

(51) Int. Cl. B32B 3/10

(52) U.S. Cl. 428/136

(57) ABSTRACT

A method of the invention consists in that at least one continuous spiral or serpentine cut is made through a flat workpiece, preferably a wooden plate, with subsequent deformation of the cutout portion in the direction perpendicular to the plane of the flat on workpiece, so that an elevated element or elements are formed on the workpiece turning it into a three-dimensional item. The cutout is made at an angle different from 90° so that the spiral or serpentine cut has a tapered shape in the thickness direction of the flat workpiece. The tapered shape of the cut facilitates fixation of the elastically deformed protruding element due friction between the engaged tapered side surfaces of the cut. The above deformation and protrusion become possible due to a certain width of the cut equal to the thickness of the cutting tool. The decorative effect can be emphasized if the workpiece is painted so that after the formation of the three-dimensional body the non-painted surfaces on the sides of the protruding elements, which are of a color different from the painted surface, form a pattern of different color on the painted background. If necessary, these side surfaces can be colored with the same or different paint. The products can be formed as decorative articles or as various functional items such as fruit or bread holders, or the like. The invention also relates to articles produced by the aforementioned method.

### FIELD OF THE INVENTION

The present invention relates to manufacturing three-dimensional objects, such as decorative panels, souvenirs, landscape models with elevated elements, maps, puzzles, murals, wall decorations, and the like. More specifically, the invention relates to a simple and efficient method of manufacturing three-dimensional objects from a flat workpiece by a single or several continuous cuts. The invention also relates to various three-dimensional objects produced by the above method.

### BACKGROUND OF THE INVENTION

There exist a variety of different methods and apparatuses for manufacturing three-dimensional objects such as decorative panels, souvenirs, furniture parts, landscape models with elevated elements, etc.

For example, French Patent No. 2,741,564 issued in 1997 to G. Boudriot discloses a three-dimensional decorative article which consists of a rigid backing layer of plywood cut to a required shape which can be covered with a layer of cork and then decorated with a part of decoration made of one or more zones of a sculpted synthetic foam such as polyurethane. The synthetic foam is applied in two layers to the backing layer after it has first been coated with at least two layers of matt white vinyl paint. The first layer of foam is pressed against the backing layer, and one or more additional are applied on top of the first layer with subsequent drying, cutting, and polishing the obtained laminated object. The finished product is colored with thin coats of spray paint. A disadvantage of this method consists in that it is non-repeatable, not-suitable for mass production, time-and labor-consuming, involves a plurality of operations, and use many different materials.

U.S. Pat. No. 5,499,914 issued in 1996 to P. Rist discloses a kit for forming three-dimensional decorative items from a flat workpiece of a plastic hardenable material having dimensions larger than the dimensions of the decorative item. The aforementioned item is formed by cutting out pieces from flat plastic material, e.g., by a die, and then deforming the cutout pieces into a three-dimensional parts, e.g., in a mold, with subsequent hardening of the deformed parts and assembling them into the finally shaped three-dimensional decorative item. This method is limited to preparation of article only of a predetermined shape, which is defined by the shape of the die. The die itself is a sufficiently expensive item. Transfer from the article of one type to another requires manufacturing of another die. The method of this patent is suitable for manufacturing articles of a relatively small size, since the large articles will require the use of very large dies, the use of which will make this method unjustifiable.

The prior art also addresses the general concept of creating designs on articles such as doors and cabinetry. The known prior art addresses articles formed from a core material overlaid with a veneer coating. Building paneling such as doors, shutters and cabinetry are typically formed from solid body such as a single piece of wood, or from a frame comprising vertical stiles and horizontal rails into which are inserted panels. In order to create pleasing designs on the two major surfaces of the paneling, decorative molding may be attached to, for example, the door. Or for those doors formed from a frame of vertical stiles and horizontal rails, the inserted panels may be of a different thickness than the material of the frame thus yielding a raised or lowered relief pattern for the door. However, this frame and panel type construction is costly due to the number of individual pieces requiring assembly.

For example, U. S. Pat. No. 5,722,209 issued in 1998 to P. Delaney et al. describes a process for cutting out decorative, artistic designs, and the three-dimensioned decorative and artistic products produced thereby. The process consists in that desired closed-loop contours are cut out in the form of tapered openings through the entire thickness of a flat workpiece, preferably a wooden plate. After separation of the cutout pieces their outer surface are machined for removal of some material, or the external material can be removed if cutting is carried out by routing. As a result, after the shaped cutout piece is inserted into the opening, a part of this piece will be raised over the surface of the flat base and form a relief configuration. The elevated element is fixed to the base either due to friction forces or by gluing. Thus, in order to form a three-dimensional object, the process involves cutting, removal of some material from the outer surface of the cutout piece, application of glue, and insertion into the opening. It is understood that the same result can be achieved merely by gluing separately produced elevated parts to the flat panel, and the only advantage of this invention is some insignificant saving of materials.

### BRIEF DESCRIPTION OF THE DRAWING

FIG. 1 is a three-dimensional view illustrating a process of the invention for making a spiral cut in a flat workpiece.

FIG. 2 is a cross-sectional view of the workpiece of FIG. 1 along the line II-II after forming the spiral cut.

FIG. 3 is a cross-sectional view of a three-dimensional product formed by the method of the invention from the flat workpiece of FIG. 2.

FIG. 4 is a perspective view of the three-dimensional product shown in FIG. 3.

FIG. 6 is a plan view of a map of a specific lot with elevated and deepened areas reproduced by the method of the invention as a landscape model.

FIG. 7 is a three-dimensional view of a landscape model produced by the method of the invention in compliance with the map of the lot shown in FIG. 4.

FIGS. 8-11 are examples of three-dimensional products obtained by the method of the invention.

### OBJECTS AND SUMMARY OF THE INVENTION

It is an object of the invention to provide a method for manufacturing three-dimensional objects from a single flat workpiece by a continuous cut with subsequent transformation of the flat object into a three-dimensional body. Another object is to provide a method in which a three-dimensional object is formed without any waste of the material. Still another object is to provide a method suitable for manufacturing three-dimensional objects of different shapes and functions in a single step and without the use of special dies or other instruments. Another object is to provide various decorative or functional objects produced by the method of the invention.

A method of the invention consists in that at least one continuous spiral or serpentine cut is made through a flat workpiece, preferably a wooden plate, with subsequent deformation of the cutout portion in the direction perpendicular to the flat surface of the workpiece, so that an elevated element or elements are formed on the workpiece. As a result, a flat workpiece is turned into a three-dimensional item. The cutout is made at an angle different from 90° so that the spiral or serpentine cut has a tapered shape in the thickness direction of the flat workpiece. The tapered shape of the cut facilitates fixation of the elastically deformed protruding element due friction between the engaged tapered side surfaces of the cut. The above deformation and protrusion become possible due to a narrow width of the cut equal to the thickness of the cutting tool. The decorative effect can be emphasized if the workpiece is painted so that after the formation of the three-dimensional body the non-painted surfaces on the sides of the protruding elements, which are of a color different from the painted surface, form a pattern of different color on the painted background. If necessary, these side surfaces can be colored with the same or different paint. The products can be formed as decorative articles or as various functional items such as fruit or bread holders, or the like.

### DETAILED DESCRIPTION OF THE INVENTION

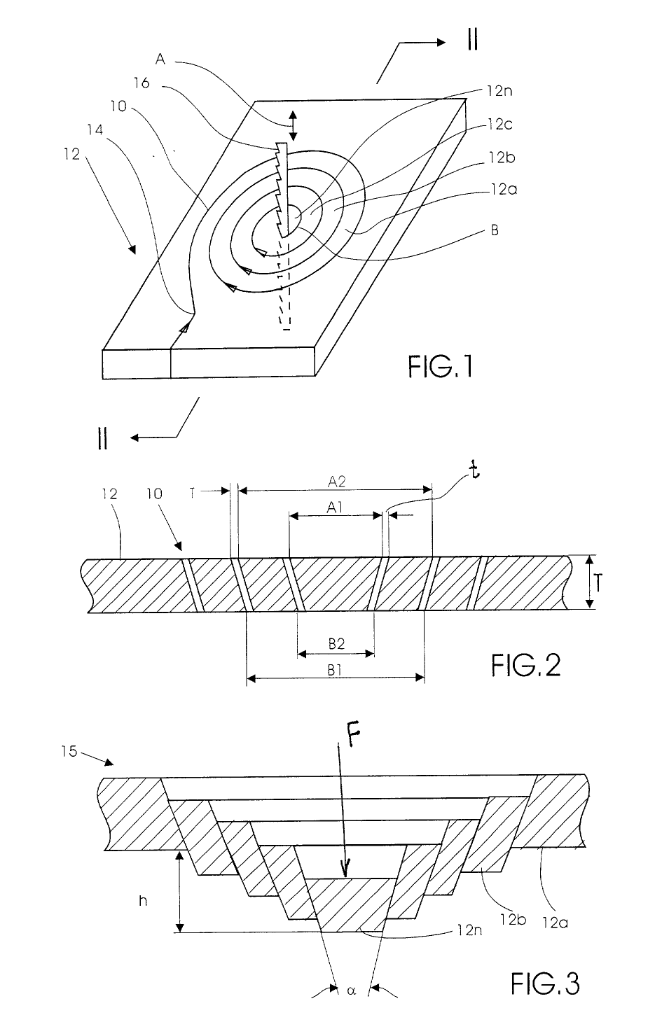

FIG. 1 is a three-dimensional view illustrating a process of the invention for making a continuous spiral cut 10 in a flat workpiece 12. The workpiece may comprise a wooden plate, a piece of plywood, a plastic sheet, a wooden chip board, a laminated plate, a metal plate, etc. The use of a wooden plate, however, is preferable. The plate may be naturally or artificially deformed with slight curvature but the use of a flat plate is preferable. In general, a plate-like workpiece made of any material with resilient properties is suitable for the method of the invention. Although there are no special limitations with regard to the thickness of the plate-like workpiece, it is recommended to use plate having a thickness from several millimeters to several centimeters. It is preferable to have a workpiece with a preliminarily treated surface. The surface can be painted, preferably with the paint having color different from the natural color of the material of the plate.

As shown in FIG. 1, the continuous spiral cut 10 made through the entire thickness of the flat workpiece 12 is started from a side 11 of the workpiece to some point 14 inside the workpiece 12 and then continued along a spiral path winding in the inward direction. In the embodiment shown in FIG. 1, cutting is carried out with the use of a jigsaw blade 16 that performs reciprocating movements in a vertical direction shown by the double-headed arrow A and a feed movements along a spiral path 10 in the direction shown by the arrow B, It is understood that the jigsaw blade is shown only as an example. It is important to note that the cut 10 is made at an angle different from 90° so that the spiral cut 10 tapers in the thickness direction of the flat workpiece 12. The tapered shape of the cuts is seen in FIG. 2, which is a cross-sectional view of the workpiece of FIG. 1 along the line II-II after the spiral cut is completed.

If in approximation the adjacent turns 12a, 12b, . . . 12n of the spiral cut 10 are considered as a group of concentric circles, than it can be seen that the “diameter” A₁ on the front surface of the workpiece 10 exceeds the diameter B₁ on the back surface by the doubled thickness “t” of the cut. Similarly, the “diameter” A₂ on the front surface of the workpiece 10 exceeds the diameter B₂ on the lower surface by the doubled thickness “t” of the cut, and so on (FIG. 2). In other words, a distance between two arbitrary points of the curvilinear path 10 on the front surface 13 is greater than a distance between corresponding points on the back surface 17 (FIG. 2).

As can be seen from FIG. 3, which is a cross-sectional view of a three-dimensional product formed by the method of the invention from the cut workpiece 10 of FIG. 2, the thickness T and the width “t” of the cut determine the height of projection (h) of the raised area formed by the method of the invention.

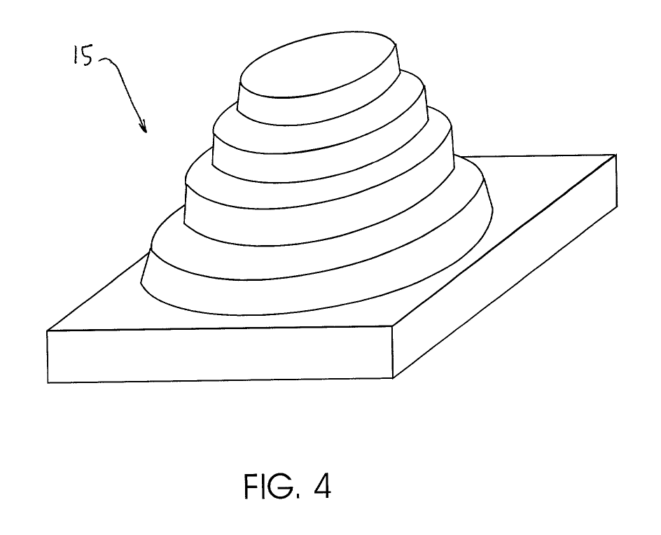

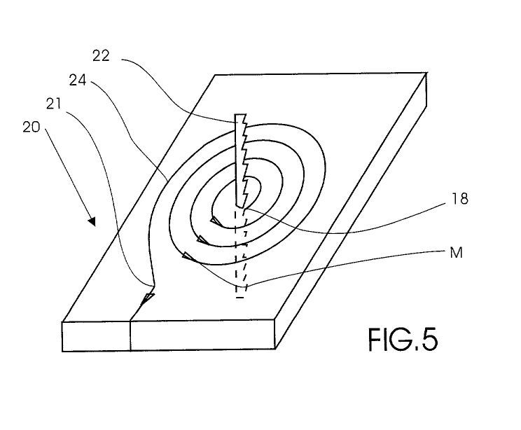

It can be seen from FIG. 2 that the workpiece 12 with the spiral cut 10 is turned from a flat object shown in FIGS. 1 and 2 into a three-dimensional object 15 shown in FIGS. 3 and 4 by applying a force F (FIG. 2) to the area of the innermost turn 12n of the spiral cut 10. The force F is applied from the side of the workpiece 12 where the turns have a larger “diameter”. FIG. 4 is a perspective view of the three-dimensional product 15 shown in FIG. 3. The transfer from the condition of FIG. 2 into condition of FIG. 3 is accompanied by elastic deformation of the turns 12a, 12b, . . . 12n which are gradually deformed and projects to the elevation which increases from the outer turns to the inner turns, so that the outermost turn 12n has the maximum elevation h above the lower surface of the workpiece 12. The elastically deformed turns 12a, 12b, . . . 12n can be maintained in a deformed state, either due to the friction between the outer surface of each turn with the inner surface of the adjacent outer turn or due to the use of a glue (not shown) applied onto the engaged surfaces. The friction force can held the three-dimensional object 15 in a deformed state if the taper angle a is relatively small and sufficient for developing a pressure angle and if the coefficient of friction on the engaging surface is high. The optimum values of the taper angle a are chosen experimentally.

FIG. 5 shown an embodiment of the invention in which the same three-dimensional object 15 as shown in FIGS. 1-4, can be formed by starting the initial cut from inside the central opening 18 formed in a flat workpiece 20 with the feed of the cutting tool 22 in the direction of the arrow M. Upon completion of the cut 24, the tool 22, which is shown as a reciprocating jigsaw blade, is removed through the outer side of the workpiece 20 at point 21. Conversion of the flat workpiece 20 with the spiral cut 24 into the three-dimensional object 15 (FIG. 4) is carried out in the same manner as described with reference to FIGS. 1-4.

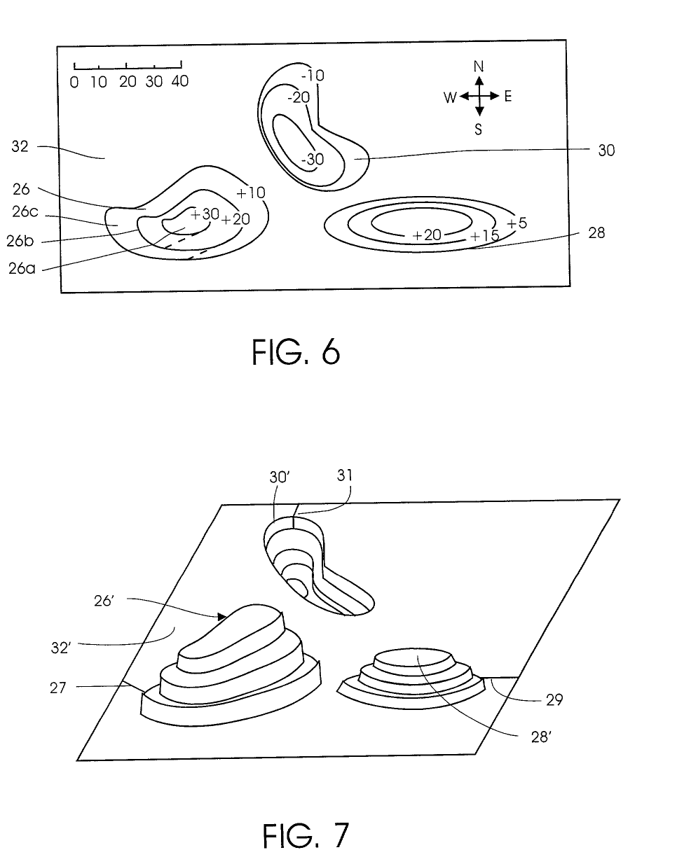

The embodiment of FIG. 1 illustrates the simplest version in which the pitch (A₂₋A₁)/2 between the adjacent turns is uniform. It is understood that in reality the method of the invention can be realized in a variety of embodiments with a pitch variable between the turns as well as along the turns. Not only the pitch between and along the turned can be changed, but also the curvature of the cut trajectory can be changed from positive to negative or vice verse. This can be seen from FIG. 6, which is a plan view of a map of a specific lot with elevated areas 26 and 28 and deepened area 30. FIG. 7 is a three-dimensional view of a landscape model produced by the method of the invention in compliance with the map of the lot shown in FIG. 4. It can be seen that the iso-altitude lines 26a, 26b, 26c, which correspond to different elevations above the flat surface 32, may have variable pitch and variable curvatures that reflects a relief of a real landscape. According to the method of the invention, the iso-altitude lines 26a, 26b, 26c can be approximately represented as turns of a continuous spiral (the portions of which are shown in FIG. 6 by broken lines). In FIG. 7, the elements of the landscape shown in the map of FIG. 6 are designated by the same reference numerals with an addition of a prime. Thus the model of landscape shown in FIG. 7 illustrates hills 26′, 28′ and a hollow 30′.

FIG. 7 shows that a three-dimensional object produced by the method of the invention can be formed by making several continuous cuts. The initial portions where the tool is cut into the workpiece from the outer sides are shows by reference numerals 27, 29, and 31.

It is understood that, in order to ensure stability of the raised and deepened turns in a deformed state shown in FIG. 7, the angle of inclination of the cutting tool (which corresponds to taper angle a shown in FIG. 3) should have a different direction with respect to the perpendicular to the plate when cutting the areas for elevated and deepened regions.

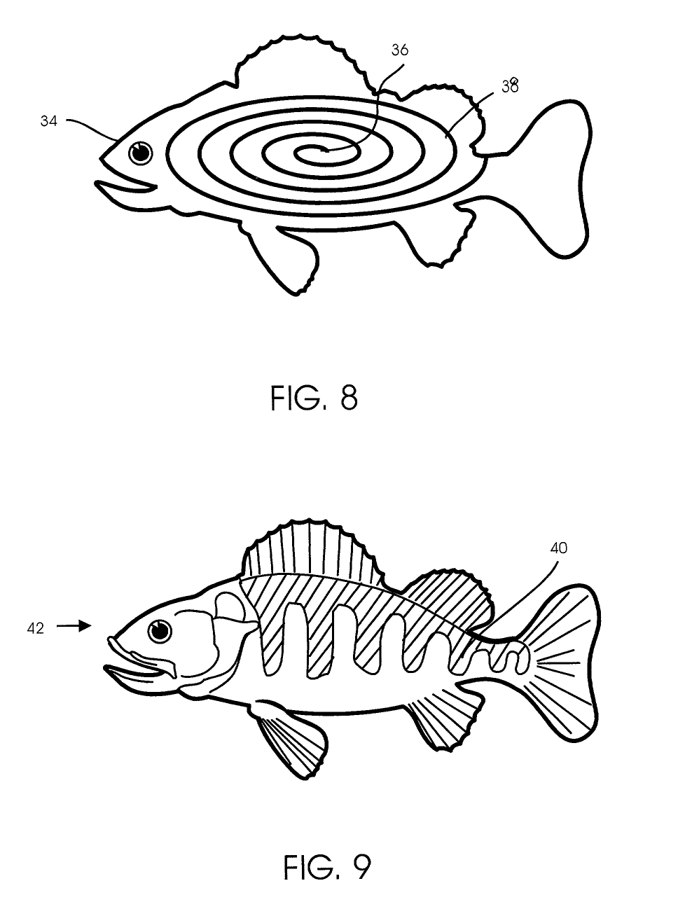

The workpiece can be prepared in the form of a shaped article that can be painted prior to making a continuous cut. FIG. 8 is an example of a decorative article in the form of a fish 34. Prior to cutting, the workpiece was painted with a dark paint so that after deformation of the flat workpiece into a three-dimensional articles by applying a force from the central area 36 in the direction perpendicular to the plane of the drawing, the unpainted spiral stripe 38, which has a natural color of the workpiece (e.g., white for a wooden plate) will produce an additional decorative effect on the dark background of the painted workpiece. The continuous cut can be made not only along a spiral path, but also along a serpentine path 40 of the type shown in FIG. 9. In other words, the invention covers a method of performing at least one continuous cut in the workpiece through the entire thickness of the workpiece along a curvilinear path, which changes direction to opposite at least in one section of the path.

In the case of a decorative article in the form of a fish 42, the aesthetical effect can be emphasized by painting the surfaces divided by the cut 40 in different colors (FIG. 9). An additional effect is produced by the unpainted areas of the type shown in FIG. 8 and designated by reference numeral 38.

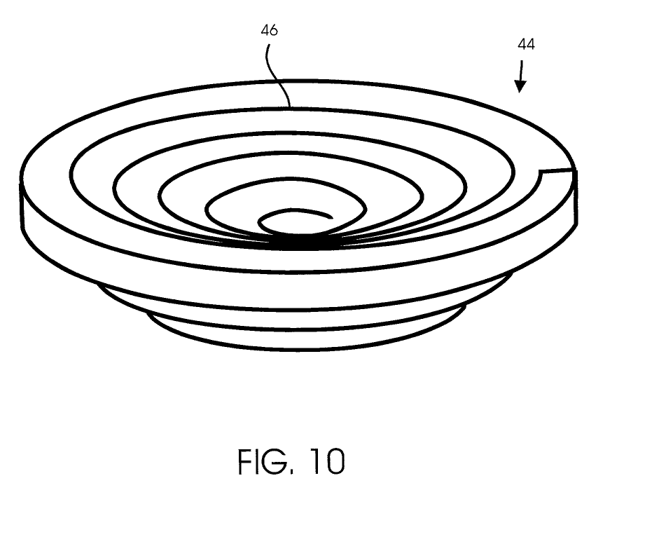

FIG. 10 illustrates a utility product, such as a bread holder 44, which is easily formed by the method of the invention from the plate with he cut of the type shown in FIG. 2. In the case of the product of FIG. 10, the workpiece is made in an elliptical form and each turn of the continuous spiral cut is also substantially elliptical.

It has been shown that the invention provides a method for manufacturing three-dimensional objects from a single flat workpiece by a continuous cut with subsequent transfer of the flat object into a three-dimensional body. The method is carried out without any waste of the material. The method is suitable for manufacturing three-dimensional objects of different shapes and functions in a single step and without the use of specials dies or other instruments. The invention is suitable for the production of various decorative or functional objects.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, three-dimensional objects produced by the method of the invention may have shapes different from those shown in FIGS. 7-10. The articles can be produced from different material and may have different topology of the elevated areas. The relief areas can be combined and arranged one inside the other. Two or more workpieces with continuous cuts can be combined to form a new product. For example, two three-dimensional articles can be connected by hinges to form a bottle cover. The three-dimensional objects can be produced by the method of the invention for turning back into a flat form for convenience of transportation and storage. Cut can be made by tools other than a jigsaw, e.g., by a small-diameter end mill, laser beam, high-pressure water jet, etc. The relief articles produced by the method of the invention may constitute decorative elements of furniture or panels.

1. A method for manufacturing a three-dimensional object from a substantially flat object by a continuous cut comprising:
providing a substantially flat workpiece having a front surface, back surfaces, sides, and a thickness;
making at least one initial cut through said workpiece with a cutting tool;
performing at least one continuous cut in said workpiece through said entire thickness along a curvilinear path in one direction and changing the direction of said path at least in a section of said path to the direction opposite to said one direction;
removing said cutting tool from said workpiece at the end of said curvilinear path; and
forming said three-dimensional object by applying to said workpiece a force substantially perpendicular to said workpiece in order to form an elevated area on said workpiece, said force being applied to a surface selected from said front surface and said back surface in the area of said end of said curvilinear path.

2. The method of claim 1, wherein said workpiece is made from a material selected from a group consisting of wood, plastic, plywood, chipboard, and a metal plate, said material having a natural color.

3. The method of claim 1, wherein in a cross-section perpendicular to said front surface said cut is tapered.

4. The method of claim 3, wherein said curvilinear path is selected from a group consisting of a spiral path and a serpentine path.

5. The method of claim 3, wherein a distance between two arbitrary points of said curvilinear path on said front surface is greater than a distance between corresponding points on the back surface.

6. The method of claim 5, wherein at least a portion of said workpiece is painted at least on said front surface with a color different from said natural color of said material of said workpiece.

7. The method of claim 1, wherein said workpiece is cut with a plurality of said curvilinear cuts along a plurality of said continuous paths for forming a plurality of said elevated areas.

8. The method of claim 7, wherein said workpiece is made from a material selected from a group consisting of wood, plastic, plywood, chipboard, and a metal plate, said material having a natural color.

9. The method of claim 7, wherein in a cross-section perpendicular to said front surface said cut is tapered.

10. The method of claim 9, wherein said curvilinear path is selected from a group consisting of a spiral path and a serpentine path.

11. The method of claim 9, wherein a distance between two arbitrary points of said curvilinear path on said front surface is greater than a distance between corresponding points on the back surface.

12. The method of claim 11, wherein at least a portion of said workpiece is painted at least on said front surface with a color different from said natural color of said material of said workpiece.

13. A method for manufacturing a three-dimensional model of a landscape corresponding to an area on a map comprising:
providing a map with an area of interest having elements of relief selected from elevated areas and hollows, said elevated areas and hollows being shown in said map in the form of a plurality of closed iso-altitude lines designated with a plus sign for elevated areas and with a minus sign for hollows;
providing a substantially flat workpiece corresponding in its shape to said area of interest of said map and having a front surface, back surfaces, sides, and a thickness;
selecting one of said areas of interest on said map to define a selected area of interest;
making an initial cut with a cutting tool through said workpiece near said selected area of interest;
performing at least one continuous cut along a spiral path with turns of said spiral path approximately corresponding to said closed lines of said relief, said cut being made through said entire thickness;
removing said cutting tool from said workpiece at the end of said curvilinear path;
repeating said steps from selecting to removing for the remaining areas of interest; and
forming said three-dimensional object by applying a force substantially perpendicular to said workpiece in said end of each of said curvilinear paths in one direction for said elevated areas and in a direction opposite to said one direction for said hollows.

14. The method of claim 13, wherein said workpiece is made from a material selected from a group consisting of wood, plastic, plywood, chipboard, and a metal plate, said material having a natural color.

15. The method of claim 13, wherein in a cross-section perpendicular to said front surface said cut is tapered.

16. The method of claim 13, wherein a distance between two arbitrary points of said curvilinear path on said front surface is greater than a distance between corresponding points on the back surface.

17. A three-dimensional object formed from a substantially flat workpiece by a continuous cut through said workpiece from an initial point, said workpiece having a front surface, back surfaces, sides, and a thickness, said three-dimensional object comprising at least one elevated area elevated from a surface selected from said front surface and said back surface, said continuous cut passing through said entire thickness along said curvilinear path in one direction and changing the direction at least in a section thereof to the direction opposite to said one direction; said elevated area being formed after cutting by applying a force to a position of said at least one elevated area in a direction perpendicular to a surface selected from said front surface and said back surface; said elevated area comprising a continuous turn formed between two adjacent lines of said curvilinear path.

18. The three-dimensional object of claim 17, wherein said workpiece is made from a material selected from a group consisting of wood, plastic, plywood, chipboard, and a metal plate, said material having a natural color.

19. The three-dimensional object of claim 17, wherein in a cross-section perpendicular to said front surface said cut is tapered and wherein said continuous turn that forms said at least one elevated area remains in an elevated state due to friction forces developed between surfaces separated by said continuous cut.

20. The three-dimensional object of claim 19, wherein said curvilinear path is selected from a group consisting of a spiral path and a serpentine path.

21. The three-dimensional object of claim 19, wherein a distance between two arbitrary points of said curvilinear path on said front surface is greater than a distance between corresponding points on the back surface.

22. The three-dimensional object of claim 21, wherein at least a portion of said workpiece is painted at least on said front surface with a color different from said natural color of said material of said workpiece.

23. The three-dimensional object of claim 17, wherein said workpiece is cut with a plurality of said curvilinear cuts along a plurality of said continuous paths for forming a plurality of said elevated areas.

24. The three-dimensional object of claim 23, wherein said workpiece is made from a material selected from a group consisting of wood, plastic, plywood, chipboard, and a metal plate, said material having a natural color.

25. The three-dimensional object of claim 24, wherein in a cross-section perpendicular to said front surface said cut is tapered.

26. The three-dimensional object of claim 25, wherein said curvilinear path is selected from a group consisting of a spiral path and a serpentine path.

27. The three-dimensional object of claim 26, wherein a distance between two arbitrary points of said curvilinear path on said front surface is greater than a distance between corresponding points on the back surface.

28. The three-dimensional object of claim 17, wherein said object is selected from a group consisting of decorative articles and utility articles.

29. The three-dimensional object of claim 17, comprising a three-dimensional model of a landscape corresponding to an area on a map having an area of interest with elements of relief selected from elevated areas and hollows, said elevated areas on a map corresponding to said elevated area on said three-dimensional object raised in one direction and said hollows correspond to said elevated areas on said three-dimensional object raised in the direction opposite to said one direction, said elevated areas on said map and said and hollows on said map being shown in the form of a plurality of closed iso-altitude lines designated with a plus sign for elevated areas and with a minus sign for hollows; in approximation, in each of said elevated areas said continuous turn representing said closed iso-altitude lines.

30. The article produce by the method claimed in claim 1.

31. The article produce by the method claimed in claim 6.

32. The article produce by the method claimed in claim 7.
